(19) United States
(12) Patent Application Publication
(10) Pub. No.: US 2007/0120949 A1
(43) Pub. Date: May 31, 2007

(54) Video, sound, and voice over IP integration system

(75) Inventor: Chih-Hsin Chuang, Taipei City (TW)

Correspondence Address: BIRCH STEWART KOLASCH & BIRCH, PO BOX 747, FALLS CHURCH, VA, 22040-0747, US

(73) Assignee: INVENTEC MULTIMEDIA & TELECOM CORPORATION

(21) Appl. No.: 11/283,997

(22) Filed: Nov. 22, 2005

(51) Int. Cl. H04N 7/14

(52) U.S. Cl. 348/14.01

(57) ABSTRACT

An Integration system for video, sound, and Voice over IP is provided. The video, sound, and Voice over IP integration system comprises a display, a phone handset, a keypad, a camera, VGA input/output ports, and a sound input/output ports. The VGA input port and sound input port of the video, sound, and Voice over IP system are coupled with the VGA output port and the sound output port of a mobile computer. The conference information can be transferred to the receiving terminal through the Internet from the mobile computer that is coupled with the video, sound, and voice internet phone integration system. Thus, the conference information can be displayed on a Video, voice over IP apparatus at the receiving terminal. Furthermore, the image display size can be increased by coupling the VGA output port of the video, sound and Voice over IP integration system with a digital projector, and the voice volume can also be increased by coupling the audio output port with an external amplifier.

### BACKGROUND OF THE INVENTION

1. Field of the Invention

The present invention is related to a Voice over IP system, specifically, to a Voice over IP system integrated with video and sound.

2. Description of the Prior Art

Voice over IP (VOIP) is a technology allowing users to deliver voice stream over the Internet Protocol. Voice stream are transferred in the form of data packets through the Internet. Using VoIP technology, telephony services can be accomplished over the Internet instead of the traditional public switched telephone network (PSTN).

A VoIP system delivers a digitized voice stream and carries out an end-to-end communication by taking advantage of the relevant Internet protocols. The VoIP technology employs multiple techniques to correct possible distortion, echo, jitter or data loss such that the voice fidelity can be preserved as much as possible.

The continued proliferation and expansion of Intranet and Internet has allowed better work collaboration among workers in physically different locations. Examples of such collaborations include sharing of documents, fast communication via e-mail, and a remote presentation session utilizing VoIP technology

In the case of a remote presentation, however, the presentation data files usually have to be distributed in advance to the participants at the receiving end. In one scenario, compatibility of computer or software to access the files may cause problems. In another scenario, occasional amendment or supplement to the presentation data may cause inconsistency if the final update fails to be delivered in time.

To avoid those scenarios, a presenter may choose to deliver the presentation content in real time by using a image capture device, such as a web-cam, pointing directly at his/her computer screen. In such case, resolution and fidelity of the image capture device must be taken into consideration for the presentation quality.

### SUMMARY OF THE INVENTION

In view of the foregoing, the present invention extends the capability of a video, voice over IP (VVOIP) system into a remote presentation tool.

An object of the present invention is to integrate video input function to a VVoIP system. By connecting the computer display output directly to the integrated VVoIP system of the present invention, video information such as file contents shown on the computer screen can be transmitted to the receiving terminal through Internet. This method will allow the presentation content on the computer to be delivered in real time to the remote end without the use of an image capture device.

Another object of the present invention is to integrate audio or sound input to a VVoIP system. By connecting the audio input of the integrated VVoIP system of the present invention with a computer's audio output, audio information from a computer can be delivered to a remote site during the session of, for example, a web conference.

According to above objects, the present invention provides an integration system for video, sound, and Voice over IP. The video, sound, and Voice over IP integration system comprises a display, a phone handset, a keypad, a camera, VGA input/output ports, and audio input/output ports. The VGA input port and the audio input port of the video, sound, and Voice over IP integration system are coupled with the VGA output port and the audio output port of a computer. Conference information can be delivered to the receiving terminal through the Internet from the computer coupled with the video, sound, and Voice over IP integration system. Thus, the conference information can be displayed on another Video, Voice over IP apparatus at the receiving terminal. Furthermore, the image display size can be increased by coupling the VGA output port of the video, sound and Voice over IP integration system with a digital projector, and the voice volume can also be increased by coupling the audio output port with an external amplifier.

### BRIEF DESCRIPTION OF THE DRAWINGS

FIG. 1 shows a block diagram of an embodiment of the video, sound, and Voice over IP integration system according to the technology of the present invention.

FIG. 2 shows typical connections between an integrated VVoIP system according to the present invention and devices at both the transmitting and the receiving terminals.

### DETAILED DESCRIPTION OF THE INVENTION

The detailed description of the present invention will be discussed in the following embodiments, which are not intended to limit the scope of the present invention, but can be adapted for other applications.

In view of the limitation of VVoIP systems available in current market, the present invention provides a VVoIP system integrated with video and audio input/output capabilities, such that users at both end of the communications are able to use the VVoIP system as a multimedia communicator for advanced applications with one such application being remote presentation.

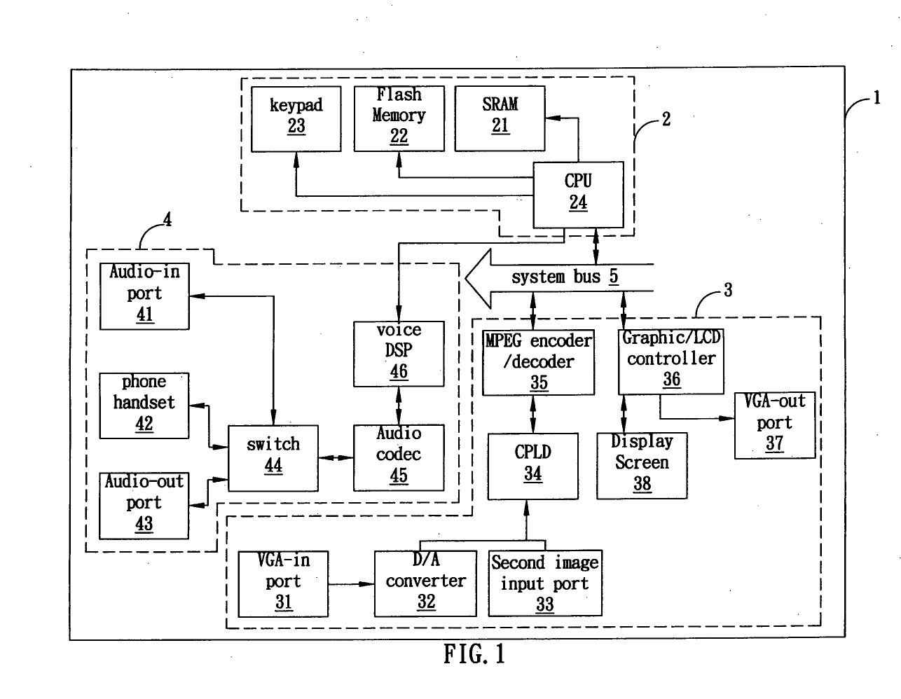

Referring to FIG. 1, a video, sound, and Voice over IP integration system 1 (that will be termed as “VoIP integration system 1” alternatively in following context) in accordance with the present invention is illustrated to consist of a control module 2, a video module 3 and an audio module 4. The control module 2, which is employed to control the video module 3 and the audio module 4, includes an SRAM (Static Random Access Memory) 21, a flash memory 22, a keypad 23, and a CPU (Central Processing Unit) 24 connected with all the other three components in the control module 2.

The video module 3, which controls the video input and output for the VoIP integration system 1, includes a VGA-in port (Video Graphic Array input port) 31 functioning as a first image input port, a D/A converter (digital-to-analog converter) 32, a second image input port 33, a CPLD (Complex Programmable Logic Device) component 34, an MPEG(Motion Picture Expert Group) encoder/decoder 35, a graphic/LCD controller 36, a VGA-out port 37 and a display screen 38. The first image input port or the VGA-in port 31 is connected to a first image input device (not shown in FIG. 1), such as a mobile computer, a desktop computer, or a PDA(Personal Digital Assistant), through a transmission line (neither shown in FIG. 1) such that the VoIP integration system 1 is able to receive a first image from the first image input device, wherein the first image is a digital signal. The D/A converter 32 receives the first image and converts it into an analog signal. The second image input port 33 is connected to a second image input device(not shown in FIG. 1), such as a CCD camera, so as to capture a second image, wherein the second image captured by the second image input port 33 is analog. It is up to a user's choice to select either the first image through the VGA-in port 31 or the second image through the second image input port 33 to be delivered to the receiving end.

Both of the converted analog version of the first image signal or the second image signal can be fed to the CPLD component 34. According to the selection of an end user, the CPLD component 34 passes either the first image signal from the VGA-in port 31 or the second image signal from the second image input port 33 to the MPEG decoder/encoder 35. MPEG decoder/encoder 35 is connected to the CPU 24 in control module 2 through a system bus 5. The graphic/LCD controller 36 is connected to the display screen 38 and the VGA-out port 37 as well as to the CPU 24 in control module 2 through the system bus 5, wherein the graphic/LCD controller 36 is employed to control output of pictures or images and to drive an external image output device (not shown in FIG.1). If the LCD controller is not powerful enough, a graphic controller should be enabled to facilitate the driving capability to the external image output device. The output of pictures or images controlled by the graphic/LCD controller 36 could go to the display screen 38 or to the external image output device connected to the VGA-out port 37. For example, the external image output device can be an LCD display or a projector.

The audio module 4, which is designed to control the sound effect and the voice input and output regarding the VoIP integration system 1, includes an audio-in port 41, a phone handset 42, an audio-out port 43, a switch 44, an audio codec 45, and a voice DSP (Digital Signal Processor) 46. Switch 44 receives an audio signal from the audio-in port 41 and passes it to the audio codec 45 which converts the analog audio signal to a digital signal. The voice DSP 46, which is connected with the audio codec 45 and the CPU 24 in control module 2, processes the digital audio signal from audio codec 45, then the processed digital audio signal is outputted through the audio codec 45 and the switch 44 in turn to either the built-in phone handset 42 or an external audio output device (not shown in FIG. 1) coupled to the audio-out port 43 according to the choice of a user. The external audio output device, for example, could be a stereo speaker.

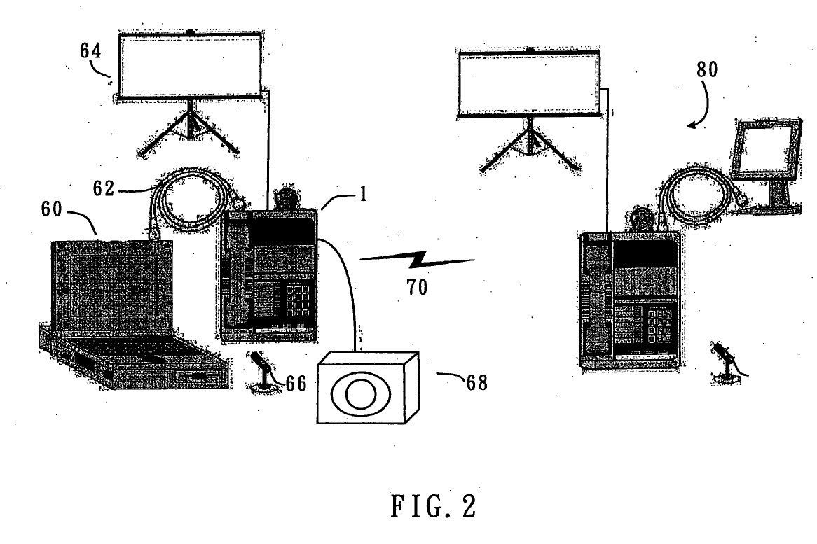

Referring to FIG. 2 which is a preferred embodiment according to the present invention, the Internet connection between the transmitting end and the receiving end is illustrated in a diagram, wherein the transmitting end contains a VoIP integration system 1 and an image input device. The VGA-in port (not shown in FIG. 2) of the VoIP integration system 1 is connected with an image input device 60 through a transmission line 62, wherein the image input device 60 can be a mobile computer (as shown in the preferred embodiment of FIG. 2), a desktop computer, or a PDA. Moreover, the VGA-out port (not shown in FIG. 2) of the VoIP integration system 1 is connected with an external image output device 64, such as a CRT monitor or an LCD display, such that when the image data generated from the image input device 60 is being delivered out, the larger size image output device 64 can simultaneously display image data being transmitted from the receiving end 80.

On the other hand, the VoIP integration system 1 further contains an audio-in port and an audio-out port (neither shown in FIG.2), wherein the audio-in port is connected with either a computer 60 or a voice input device 66, such as a microphone. The audio-out port of the VoIP integration system 1 is connected with an external audio output device 68 such as an amplifier. Thus, through the Internet connection 70, the receiving end 80 can access either the sound effect generated from the computer 60 connected to the VoIP integration system 1 at the transmitting(client) end or the voice data inputted via the voice input device 66.

As described above, it becomes clear that, through connection with a mobile computer and an external audio output device, the video, sound, and voice over IP integration system provided by the present invention receives and processes picture or image data from the mobile computer. After the conversion through the D/A converter, the picture or image data goes through the complex programmable logic device and is encoded by the MPEG encoder/decoder. The encoded data then goes to the system bus controlled by the CPU and is delivered via internet to receiving end. In the receiving end, as the encoded picture or image data is received, the MPEG encoder/decoder will decode the received data and then passes the result either to the built-in display or to an external connected monitor through the system bus under the control of the CPU. In this way, it will not be a problem even though someone participating in the conference has troubles to receive or access the presentation data.

At the same time, in the transmitting end, through the system bus and the graphic/LCD controller, the picture or image data also goes to the VGA output port of the VoIP integration system and is outputted to an external connected image output device in connection with the VGA output port.

Through interactive switching of buttons in the video, sound, and voice over IP integration system (and thus affecting the internal setting of the complex programmable logic device shown in FIG. 1), an end user can select to use a web camera or the VGA input port for a web conference. Additionally, sound effect from a mobile computer or voice from a voice input device can be enabled to further enhance the video, sound, and voice over IP integration system according to the present invention.

Although only preferred embodiments have been illustrated and described, it will be appreciated by those skilled in the art that various modifications may be made without departing from the scope of the present invention, which is intended to be limited solely by the appended claims.

What is claimed is:

1. A voice over IP integration system comprising:
at least one image input port for connection with an image input device, and for inputting an image;
a complex programmable logic device which is coupled with said at least one image input port to select said image to be processed;
a picture encoder/decoder which is coupled with said complex programmable logic device so as to encode said image therefrom into an encoded image;
a system bus which is coupled with said picture encoder/decoder so as to receive said encoded image passed therefrom;
a graphic/LCD controller which is coupled with said system bus so as to receive said image passed therefrom;
an image output device to output said image passed from said graphic/LCD controller;
an audio module which is employed to control voice and sound effect in said voice over IP integration system;
a control module coupled with both said audio module and said system bus.

2. The voice over IP integration system as claimed in claim 1, wherein said at least one image input port comprises a VGA input port.

3. The voice over IP integration system as claimed in claim 1, wherein said image input device comprises a mobile computer.

4. The voice over IP integration system as claimed in claim 1, wherein said image input device comprises a personal computer.

5. The voice over IP integration system as claimed in claim 1, wherein said image input device comprises a PDA (personal digital assistant).

6. The voice over IP integration system as claimed in claim 1, further comprising a D/A converter which converts said image from a digital signal to an analog signal.

7. The voice over IP integration system as claimed in claim 1, wherein said at least one image input port comprises a CCD (charge-coupled device) camera input port.

8. The voice over IP integration system as claimed in claim 7, wherein said CCD camera input port is connected with a CCD camera.

9. The voice over IP integration system as claimed in claim 8, wherein said image inputted from said CCD camera is an analog signal.

10. The voice over IP integration system as claimed in claim 1, wherein said picture encoder/decoder comprises an MPEG encoder/decoder.

11. The voice over IP integration system as claimed in claim 1, wherein said image output device comprises an external monitor connecting to an image output port through a transmission line, said image output port is connected to said graphic/LCD controller.

12. The voice over IP integration system as claimed in claim 11, wherein said external monitor is an LCD display.

13. The voice over IP integration system as claimed in claim 11, wherein said external monitor is a projector.

14. The voice over IP integration system as claimed in claim 1, wherein said image output device comprises an LCD display built in said VoIP integration system.

15. A voice over IP integration system comprising:
a first image input port to input a first image;
a D/A converter to convert said first image from a digital signal to an analog signal;
a second image input port to input a second image which is an analog signal;
a complex programmable logic device which is employed to select either said first image or said second image as the image to be processed;
a picture encoder/decoder which is employed to encode either said first image or said second image selected and passed from said complex programmable logic device;
a system bus which receives either said encoded first image or said encoded second image outputted from said picture encoder/decoder;
a graphic/display controller which receives either said first image or said second image passed from said system bus;
an image output device which receives either said first image or said second image from said graphic/display controller;
an audio input port to receive an audio input signal;
a switch which receives and determines whether to proceed to process said audio input signal or not depending on the contents thereof;
an audio codec which receives said audio input signal and converts it from an analog signal to a digital signal;
a voice digital signal processor which processes digital audio data passed from said audio codec;
an audio output port which can be connected with an external audio output device and receives and outputs audio signal through said switch.

16. The voice over IP integration system as claimed in claim 15, wherein said first image input port is connected with a first image input device through a transmission line.

17. The voice over IP integration system as claimed in claim 16, wherein said first image input device comprises a mobile computer.

18. The voice over IP integration system as claimed in claim 16, wherein said first image input device comprises a personal computer.

19. The voice over IP integration system as claimed in claim 16, wherein said first image input device comprises a PDA (personal digital assistant).

20. The voice over IP integration system as claimed in claim 15, wherein said second image input port is connected with a second image input device through a transmission line.

21. The voice over IP integration system as claimed in claim 20, wherein said second image input device comprises a CCD camera.

22. The voice over IP integration system as claimed in claim 15, wherein said picture encoder/decoder comprises an MPEG encoder/decoder.

23. The voice over IP integration system as claimed in claim 15, wherein said audio input port is connected with a voice input device.

24. The voice over IP integration system as claimed in claim 23, wherein said voice input device comprises a microphone.

25. The voice over IP integration system as claimed in claim 15, wherein said audio output port is connected with an external audio output device.

26. The voice over IP integration system as claimed in claim 25, wherein said external audio output device comprises an amplifier.

27. The voice over IP integration system as claimed in claim 15, wherein said switch is further connected to a phone handset.
